(19) United States
(12) Patent Application Publication
(10) Pub. No.: US 2025/0111759 A1
(43) Pub. Date: Apr. 3, 2025

(54) DYNAMIC MODIFICATION OF DEVICE VIBRATION HAPTICS

(71) Applicant: MOTOROLA MOBILITY LLC, WILMINGTON, DE (US)

(72) Inventors: AMIT KUMAR AGRAWAL, BANGALORE (IN); SRIKANTH RAJU, BANGALORE (IN)

(21) Appl. No.: 18/478,366

(22) Filed: Sep. 29, 2023

(51) Int. Cl. G08B 6/00

(52) U.S. Cl. CPC G08B 6/00

(57) ABSTRACT

A method provides techniques for dynamically modifying vibration haptics of an electronic device. The method includes detecting, by an electronic device comprising a haptic output device, a haptic triggering event. A first haptic output is generated in response to detecting the haptic triggering event. The method continues with waiting a predetermined duration for an acknowledgement of the first haptic output. In response to the first haptic output not being acknowledged after the predetermined duration, a haptic setting of the electronic device is changed to generate a second haptic output that has at least one parameter that differs from a corresponding parameter of the first haptic output, increasing the likelihood of getting the attention of a user in response to the triggering event.

### BACKGROUND

### 1. Technical Field

The present disclosure generally relates to electronic devices, and more specifically to electronic devices that generate device haptics.

### 2. Description of the Related Art

Smartphones have become an integral part of daily life and provide a wide range of functionality. This functionality can include communication via voice calls, text messages, and/or other messaging applications (apps). Other popular functions of smartphones include gaming, navigation, ecommerce, online banking, health and fitness tracking, and more.

Devices such as smartphones can provide alerts for a variety of events. The events can include the arrival of incoming text messages, email messages, instant messaging alerts, and voice calls. Additionally, the events can include time-based events such as calendar and reminder alerts. Other events can include environmental or circumstantial alerts such as weather alerts regarding severe weather conditions such as storms or extreme temperatures, traffic and navigation alerts. Additional events can include financial and banking alerts, such as low balance alerts, potential fraud warnings, and so on. The importance of not missing smartphone alerts can vary depending on the context. Missing certain alerts, such as emergency or critical work-related notifications, can have significant consequences. Additionally, staying informed about personal and social interactions through messaging and social media alerts helps maintain connections and relationships.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example component makeup of a communication device with specific components used to enable the device to perform dynamic haptic alert functions, according to one or more embodiments;

FIG. 2 is a graph of a first haptic pattern, according to one or more embodiments;

FIG. 3 is a graph of a second haptic pattern, according to one or more embodiments;

FIG. 4 is a graph of a third haptic pattern, according to one or more embodiments;

FIG. 5 is a graph of a fourth haptic pattern, according to one or more embodiments;

FIG. 6 is a graph of a fifth haptic pattern, according to one or more embodiments;

FIG. 7 is a graph of a sixth haptic pattern, according to one or more embodiments;

FIG. 8 is a graph of a seventh haptic pattern, according to one or more embodiments;

FIG. 9 is an example user interface for providing an option for activation of a dynamic haptic pattern feature, according to one or more embodiments;

FIG. 10 depicts a flowchart of a method for changing a haptic setting of an electronic device to generate a second haptic output that differs from the first haptic output, according to one or more embodiments; and

FIG. 11 depicts a flowchart of a method for changing parameters of a haptic setting, according to one or more embodiments.

### DETAILED DESCRIPTION

Disclosed embodiments provide a communication device, a method, and a computer program product for providing dynamic modification of haptic alerts. In one or more embodiments, a haptic triggering event is detected. The haptic triggering event can include an alert, such as for an incoming text message, voice call, in-app notification, or other event. A first haptic output is generated in response to the event. After a predetermined time period, if the notification is not acknowledged by the device user, the haptic setting of the electronic device is dynamically/automatically changed to produce a new haptic output.

In many situations, users of communication devices do not want a loud alert for incoming messages and/or events. Rather than having to present an audible notification, modern communication devices can be set to a vibrate mode. Vibrate mode allows users to receive notifications without causing noise or disruptions in quiet or public settings, such as meetings, classrooms, theaters, or libraries. In vibrate mode, there is no audible ringtone output by the electronic device. For incoming alerts received while the electronic device is in vibrate mode, a vibrator or other haptic output device provides a vibratory notification. The vibrate mode of the electronic device provides a discreet way to receive messages, calls, or notifications without drawing attention to oneself or the content of the notification. Vibrating alerts can be less disruptive than audible notifications, allowing users to stay connected without interrupting their focus or activities. Thus, the vibrate mode of electronic devices can be a useful feature in many situations. One drawback of vibrating alerts is that, over time, a user can get used to a vibration pattern. Once a user has acclimated to a vibration pattern, the user may be more prone to missing alerts. The acclimation to a vibration pattern is similar in principle to when a user first starts wearing a wristwatch, at which time the user is very cognizant of the wristwatch. Over the course of time, the user gets used to wearing the wristwatch, and no longer is constantly aware that he/she is wearing the wristwatch.

The disclosed embodiments mitigate the aforementioned problems by configuring the communication device to dynamically change a haptic output pattern in response to detecting that there are long delays in the vibratory alerts being acknowledged or that the vibratory alerts are not being acknowledged at all. Disclosed embodiments utilize additional criteria for determining when to modify the vibratory alert. For example, the dynamic modification can be triggered only when/while the electronic device is in a vibrate-only mode, as compared to a vibrate-and-ring mode, which combines both haptic and audible outputs. The additional criteria can also include the device being in an on-body state, in which the electronic device makes a determination that it is ‘on body’, such as in a pocket of clothing currently worn by a user. Electronic devices of the disclosed embodiments can utilize one or more sensors and/or peripherals, including, but not limited to, motion sensors, heat sensors, gyroscopes, and/or accelerometers, to determine an on-body state. Accordingly, disclosed embodiments may activate the dynamic haptic alert mode when the electronic device is determined to be in an on-body state and/or only when the electronic device is in a vibrate-only mode. By changing parameters of the haptic output pattern, such as frequency, amplitude, duration, and/or rhythmic pattern, a user is more likely to be aware of the vibrations associated with an incoming alert. Accordingly, the number of missed alerts due to not noticing a vibration pattern can be reduced.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, which enables the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

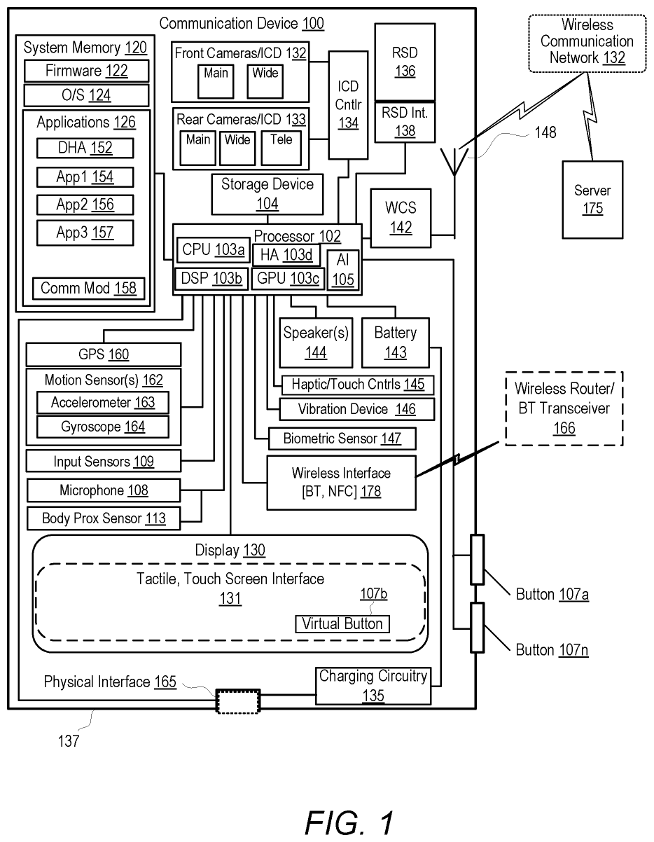

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1, there is illustrated an example component makeup of electronic device 100, within which various aspects of the disclosure can be implemented, according to one or more embodiments. According to one or more embodiments, electronic device 100 includes specific hardware and software components that enable the device to: detect a haptic triggering event; generate a first haptic output in response to detecting the haptic triggering event; wait a predetermined duration for an acknowledgement of the first haptic output; and in response to the first haptic output not being acknowledged after the predetermined duration, change a haptic setting of the electronic device to generate a second haptic output that has at least one parameter that differs from a corresponding parameter of the first haptic output. Examples of electronic device 100 include, but are not limited to, mobile devices, a notebook computer, a mobile phone, a smart phone, a digital camera with enhanced processing capabilities, a smart watch, a tablet computer, and other types of electronic device. It is appreciated that electronic device 100 can include other types of electronic devices that are capable of providing haptic outputs in response to events.

Electronic device 100 includes processor 102 (typically as a part of a processor integrated circuit (IC) chip), which includes processor resources such as central processing unit (CPU) 103a, communication signal processing resources such as digital signal processor (DSP) 103b, graphics processing unit (GPU) 103c, and hardware acceleration (HA) unit 103d. In some embodiments, the hardware acceleration (HA) unit 103d may establish direct memory access (DMA) sessions to route network traffic to various elements within electronic device 100 without direct involvement from processor 102 and/or operating system 124.

Processor 102 can, in some embodiments, include image signal processors (ISPs) (not shown) and dedicated artificial intelligence (AI) engines 105. Processor 102 is communicatively coupled to storage device 104, system memory 120, input devices (introduced below), output devices, including integrated display 130, and image capture device (ICD) controller 134.

Throughout the disclosure, the term image capturing device (ICD) is utilized interchangeably to be synonymous with and/or refer to any one of front or rear facing cameras 132, 133. Front facing cameras 132 and rear facing cameras 133 are communicatively coupled to ICD controller 134, which is communicatively coupled to processor 102. Both sets of cameras 132, 133 include image sensors that can capture images that are within the field of view (FOV) of the respective ICD 132, 133.

In one or more embodiments, the functionality of ICD controller 134 is incorporated within processor 102, eliminating the need for a separate ICD controller. Thus, for simplicity in describing the features presented herein, the various camera selection, activation, and configuration functions performed by the ICD controller 134 are described as being provided generally by processor 102. Similarly, manipulation of captured images and videos are typically performed by GPU 103c and certain aspects of device communication via wireless networks are performed by DSP 103b, with support from CPU 103a. However, for simplicity in describing the features of the disclosure, the functionality provided by one or more of CPU 103a, DSP 103b, GPU 103c, and ICD controller 134 are collectively described as being performed by processor 102. Collectively, components integrated within processor 102 support computing, classifying, processing, transmitting and receiving of data and information, and presenting of graphical images within a display. Processor 102 can also be generally referred to as a controller.

System memory 120 may be a combination of volatile and non-volatile memory, such as random-access memory (RAM) and read-only memory (ROM). System memory 120 can store program code or similar data associated with firmware 122, an operating system 124, and/or applications 126. During device operation, processor 102 processes program code of the various applications, modules, OS, and firmware, that are stored in system memory 120.

In accordance with one or more embodiments, applications 126 include, without limitation, dynamic haptic alert (DHA) module 152, other applications, indicated as 154, 156, and 157, and communication module 158. Applications 154, 156, and 157 can include applications that can generate or trigger haptic alerts. Examples of such applications can include, but are not limited to, voice calling applications, instant messaging applications, weather monitoring applications, stock price tracker applications, health and fitness applications, calendar and reminder applications, and so on. Each module and/or application provides program instructions/code that are processed by processor 102 to cause processor 102 and/or other components of electronic device 100 to perform specific operations, as described herein. Descriptive names assigned to these modules add no functionality and are provided solely to identify the underlying features performed by processing the different modules. For example, DHA 152 includes program instructions that support electronic device 100 being configured to: detect a haptic triggering event; generate a first haptic output in response to detecting the haptic triggering event; wait a predetermined duration for an acknowledgement of the first haptic output; and in response to the first haptic output not being acknowledged after the predetermined duration, change a haptic setting of the electronic device to generate a second haptic output that has at least one parameter that differs from a corresponding parameter of the first haptic output. Thus, in one or more embodiments, DHA 152 provides a module for managing and dynamically modifying an intensity of haptic responses by the electronic device. Moreover, DHA 152 can serve to enhance the effectiveness of haptic alerts generated by electronic device 100 and reduce the instances when haptic alerts are unintentionally missed due to a user not noticing a haptic output pattern.

In one or more embodiments, electronic device 100 includes removable storage device (RSD) 136, which is inserted into RSD interface 138 that is communicatively coupled via system interlink to processor 102. In one or more embodiments, RSD 136 is a non-transitory computer program product or computer readable storage device. RSD 136 may have a version of one or more of the applications (e.g., 152, 154, 156, 157, 158) and specifically DHA 152 stored thereon. Processor 102 can access RSD 136 to provision electronic device 100 with program code that, when executed/processed by processor 102, the program code causes or configures processor 102 and/or generally electronic device 100, to provide the various haptic response management functions described herein.

Electronic device 100 includes an integrated display 130 which incorporates a tactile, touch screen interface 131 that can receive user tactile/touch input. As a touch screen device, integrated display 130 allows a user to provide input to or to control electronic device 100 by touching features within the user interface presented on display 130. Tactile, touch screen interface 131 can be utilized as an input device. The touch screen interface 131 can include one or more virtual buttons, indicated generally as 107b. In embodiments, when a user applies a finger on the touch screen interface 131 in the region demarked by the virtual button 107b, the touch of the region causes the processor 102 to execute code to implement a function associated with the virtual button. In some implementations, integrated display 130 is integrated into a front surface of electronic device 100 along with front ICDs, while the higher quality ICDs are located on a rear surface.

Electronic device 100 can further include microphone 108, one or more output devices such as speakers 144, and one or more input buttons 107a-107n. Microphone 108 can also be referred to as an audio input device. In some embodiments, microphone 108 may be used for identifying a user via voiceprint, voice recognition, and/or other suitable techniques. Input buttons 107a-107n may provide controls for volume, power, and ICDs 132, 133. Additionally, electronic device 100 can include input sensors 109 (e.g., enabling gesture detection by a user), and body proximity sensor 113. The body proximity sensor 113 can include infrared, and/or other sensors to detect an on-body state of the electronic device.

Electronic device 100 further includes haptic touch controls 145, vibration device 146, fingerprint/biometric sensor 147, global positioning system (GPS) device 160, and motion sensor(s) 162. Vibration device 146 can cause electronic device 100 to vibrate or shake when activated. Vibration device 146 can be activated during an incoming call or message in order to provide an alert or notification to a user of electronic device 100. According to one aspect of the disclosure, integrated display 130, speakers 144, and vibration device 146 can generally and collectively be referred to as output devices. In one or more embodiments, the vibration device 146 can include, but is not limited to, an eccentric rotating mass (ERM) motor. The ERM motor can include an unbalanced weight mounted on the shaft of a small motor. When the motor spins, the unbalanced weight causes the device to vibrate. In one or more embodiments, the vibration device 146 can include, but is not limited to, a linear resonant actuator (LRA). The LRA can include a coil and magnet system to create vibrations. An LRA can produce a wide range of vibration patterns and intensities, making LRA suitable for dynamic haptic feedback adjustments, in accordance with one or more embodiments. In one or more embodiments, the vibration device 146 can include, but is not limited to, a piezoelectric actuator. The piezoelectric actuator can utilize the piezoelectric effect to create vibrations by applying an electric field to a piezoelectric crystal. A piezoelectric actuator can produce precise haptic feedback, making a piezoelectric actuator suitable for dynamic haptic feedback adjustments in accordance with one or more embodiments.

Biometric sensor 147 can be used to read/receive biometric data, such as fingerprints, to identify or authenticate a user. In some embodiments, the biometric sensor 147 can supplement an ICD (camera) for user detection/identification.

GPS device 160 can provide time data and location data about the physical location of electronic device 100 using geospatial input received from GPS satellites. Motion sensor(s) 162 can include one or more accelerometers 163 and gyroscope 164. Motion sensor(s) 162 can detect movement of electronic device 100 and provide motion data to processor 102 indicating the spatial orientation and movement of electronic device 100. Accelerometers 163 measure linear acceleration of movement of electronic device 100 in multiple axes (X, Y and Z). Gyroscope 164 measures rotation or angular rotational velocity of electronic device 100. Electronic device 100 further includes a housing 137 (generally represented by the thick exterior rectangle) that contains/protects the components internal to electronic device 100.

Electronic device 100 also includes a physical interface 165. Physical interface 165 of electronic device 100 can serve as a data port and can be coupled to charging circuitry 135 and device battery 143 to enable recharging of device battery 143.

Electronic device 100 further includes wireless communication subsystem (WCS) 142, which can represent one or more front end devices (not shown) that are each coupled to one or more antennas 148. In one or more embodiments, WCS 142 can include a communication module with one or more baseband processors or digital signal processors, one or more modems, and a radio frequency (RF) front end having one or more transmitters and one or more receivers. Example communication module 158 within system memory 120 enables electronic device 100 to communicate with wireless communication network 132 and with other devices, such as server 175, via one or more of data, audio, text, and video communications. Communication module 158 can support various communication sessions by electronic device 100, such as audio communication sessions, video communication sessions, text communication sessions, exchange of data, and/or a combined audio/text/video/data communication session.

WCS 142 and antennas 148 allow electronic device 100 to communicate wirelessly with wireless communication network 132 via transmissions of communication signals to and from network communication devices, such as base stations or cellular nodes, of wireless communication network 132. Wireless communication network 132 further allows electronic device 100 to wirelessly communicate with server 175, which can be similarly connected to wireless communication network 132. In one or more embodiments, various functions that are being performed on communications device 100 can be supported using or completed via/on server 175.

Electronic device 100 can also wirelessly communicate, via wireless interface(s) 178, with wireless communication network 132 via communication signals transmitted by short range communication device(s) to and from an external WiFi router (or wireless transceiver device) 180, which is communicatively connected to wireless communication network 132. Wireless interface(s) 178 can be a short-range wireless communication component providing Bluetooth, near field communication (NFC), and/or wireless fidelity (Wi-Fi) connections. In one embodiment, electronic device 100 can receive Internet or Wi-Fi based calls, text messages, multimedia messages, and other notifications via wireless interface(s) 178. In one or more embodiments, electronic device 100 can communicate wirelessly with external wireless device 166, such as a WiFi router or BT transceiver, via wireless interface(s) 178. In an embodiment, WCS 142 with antenna(s) 148 and wireless interface(s) 178 collectively provide wireless communication interface(s) of electronic device 100.

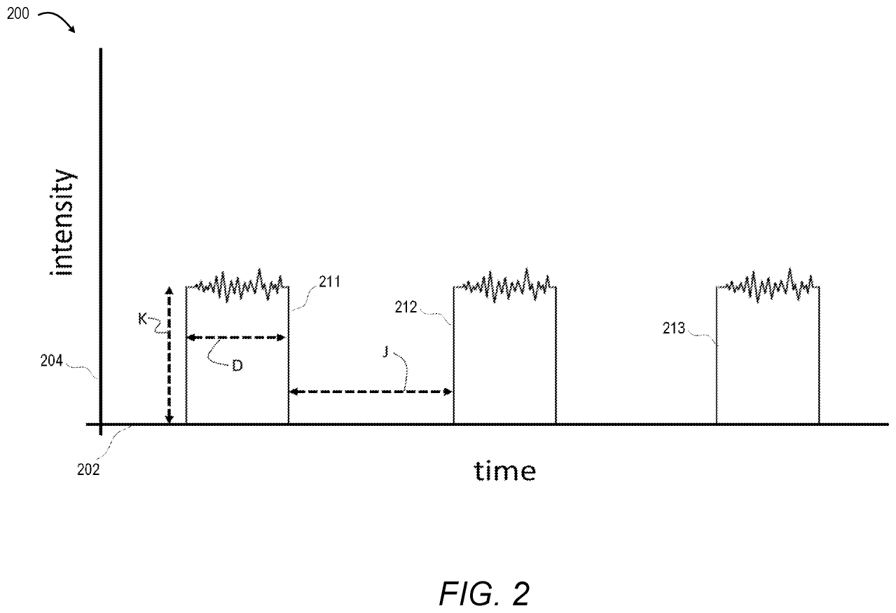

FIG. 2 is a graph 200 of a first haptic pattern, according to one or more embodiments. Graph 200 includes a horizontal axis 202 representing time, and a vertical axis 204 representing vibration intensity or amplitude. Three pulses, indicated as 211, 212, and 213 are shown, each with duration D and intensity (amplitude) K. Each pulse represents a burst of activity from a vibrator (e.g., 146 of FIG. 1) or other haptic output generator. Each pulse is separated from an adjacent pulse by an inter-pulse duration J. In one or more embodiments, the haptic pattern depicted in FIG. 2 may be a default haptic pattern for an electronic device. Over time, a user may become acclimated to the default haptic pattern. In one or more embodiments, in response to increased time to acknowledge an alert, incoming message, or incoming call, and/or unacknowledged alerts and/or calls, the haptic pattern is changed. The changed haptic pattern may be more easily noticed by a user when the phone is ‘on-body’, such as being held in a hand, or placed in a pocket. Various parameters associated with the haptic pattern can be changed to create new patterns.

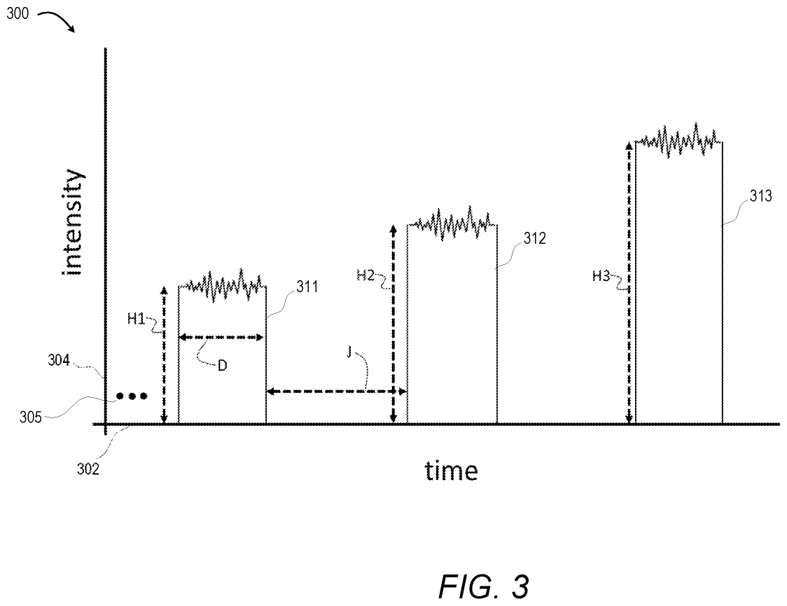

FIG. 3 is a graph 300 of a second haptic pattern, according to one or more embodiments. Graph 300 includes a horizontal axis 302 representing time, and a vertical axis 304 representing vibration intensity or amplitude. Three pulses, indicated as 311, 312, and 313 are shown, each with duration D. Furthermore, each pulse is separated from an adjacent pulse by an inter-pulse duration J. However, each pulse has a different intensity (amplitude). Pulse 311 has a first amplitude H1. Pulse 312 has a second amplitude H2. Pulse 313 has a third amplitude H3, where H3>H2>H1. In embodiments, H3 represents a maximum intensity (amplitude) that is producible by the vibration device (e.g., 146 of FIGS. 1), and H2 and H1 are reduced amplitudes, that may be denoted as percentages of the maximum amplitude. In embodiments, H2 is 70 percent of H3, and H1 is 40 percent of H3. Other values are possible in disclosed embodiments. Thus, in one or more embodiments, changing the haptic setting comprises increasing an amplitude parameter. The increasing amplitude parameter can serve to make the haptic pattern more noticeable to a user. In one or more embodiments, an initial haptic pattern, which may be similar to the pattern shown in FIG. 2, may be output for a first period of time, to give a user an opportunity to acknowledge an alert. In one or more embodiments, the first period of time ranges from four seconds to seven seconds. The pattern shown in FIG. 3 may occur after the first period. The three dots, shown at 305, indicate that a first period of time precedes pulse 311.

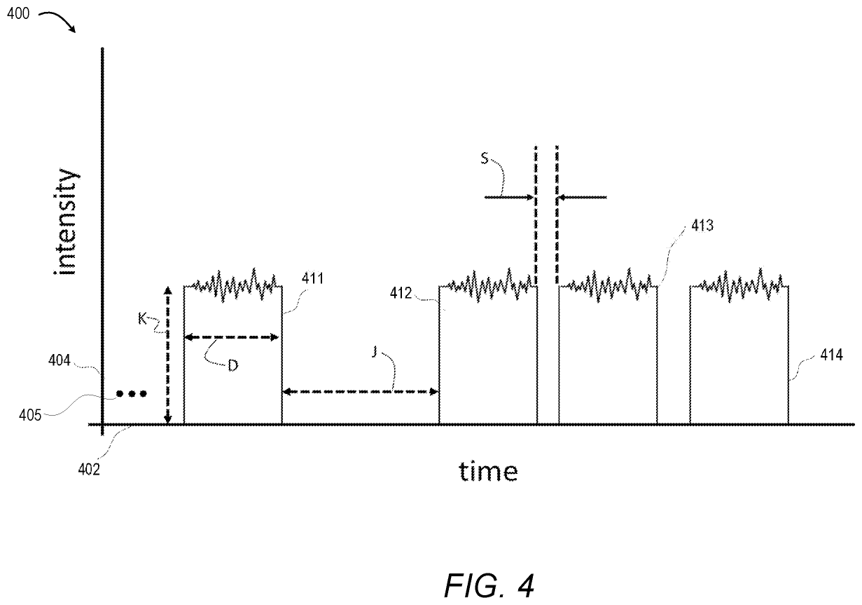

FIG. 4 is a graph 400 of a third haptic pattern, according to one or more embodiments. Graph 400 includes a horizontal axis 402 representing time, and a vertical axis 404 representing vibration intensity or amplitude. Four pulses, indicated as 411, 412, 413, and 414 are shown, each with duration D and intensity (amplitude) K. Furthermore, pulse 411 is separated from pulse 412 by an inter-pulse duration J. However, the inter-pulse duration between pulse 412 and pulse 413, and the inter-pulse duration between pulse 413 and pulse 414, is denoted by inter-pulse duration S, where S is a shorter duration than J. Thus, the frequency of the pulses increases after the initial pulse 411. In one or more embodiments, changing the haptic setting comprises increasing a frequency parameter. In one or more embodiments, an initial haptic pattern, which may be similar to the pattern shown in FIG. 2, may be output for a first period of time, to give a user an opportunity to acknowledge an alert. In one or more embodiments, the first period of time ranges from four seconds to seven seconds. The pattern shown in FIG. 4 may occur after the first period. The three dots, shown at 405, indicate that a first period of time precedes pulse 411. The increasing frequency parameter can serve to make the haptic pattern more noticeable to a user.

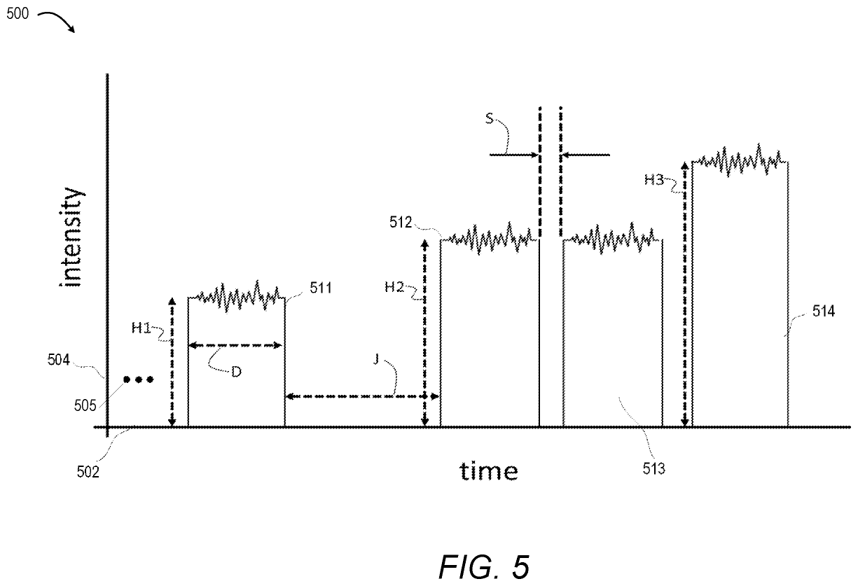

FIG. 5 is a graph 500 of a fourth haptic pattern, according to one or more embodiments. Graph 500 includes a horizontal axis 502 representing time, and a vertical axis 504 representing vibration intensity or amplitude. Four pulses, indicated as 511, 512, 513, and 514 are shown, each with duration D. Furthermore, pulse 511 has an intensity (amplitude) H1, and is separated from pulse 512 by an inter-pulse duration J. However, the inter-pulse duration between pulse 512 and pulse 513, and the inter-pulse duration between pulse 513 and pulse 514, is denoted by inter-pulse duration S, where S is a shorter duration than J. Additionally, pulse 512 and pulse 513 have an intensity (amplitude) H2, where H2 is greater than H1. Furthermore, pulse 514 has an intensity (amplitude) H3, where H3 is greater than H2. Thus, the frequency and amplitude of the pulses increase after the initial pulse 511. In one or more embodiments, changing the haptic setting comprises increasing a frequency parameter and an amplitude parameter. In one or more embodiments, an initial haptic pattern, which may be similar to the pattern shown in FIG. 2, may be output for a first period of time, to give a user an opportunity to acknowledge an alert. In one or more embodiments, the first period of time ranges from four seconds to seven seconds. The pattern shown in FIG. 5 may occur after the first period. The three dots, shown at 505, indicate that a first period of time precedes pulse 511. The combination of the increasing frequency parameter and increasing amplitude parameter can serve to make the haptic pattern more noticeable to a user.

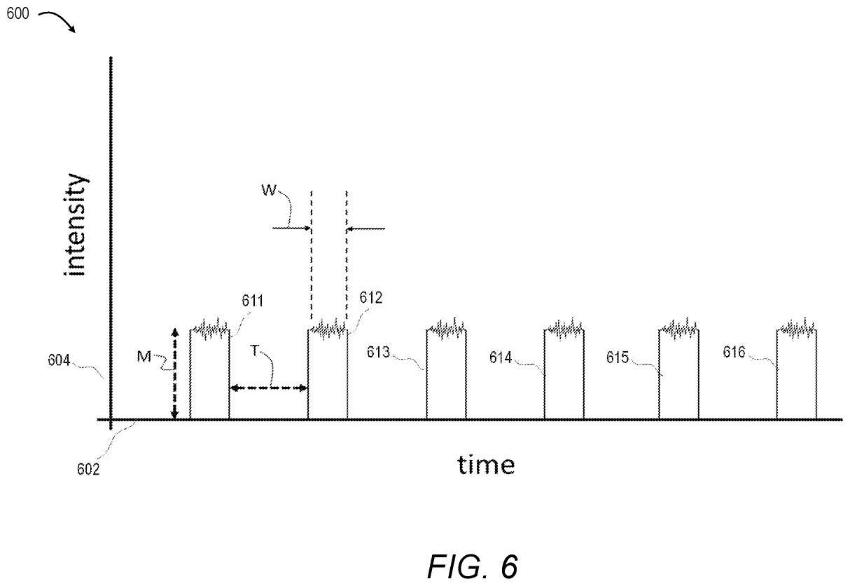

FIG. 6 is a graph 600 of a fifth haptic pattern, according to one or more embodiments. Graph 600 includes a horizontal axis 602 representing time and a vertical axis 604 representing vibration intensity or amplitude. A periodic sequence of pulses, indicated as 611-616 are shown, each with duration W and intensity M. Each pulse represents a burst of activity from a vibrator (e.g., 146 of FIG. 1) or other haptic output generator. Each pulse is separated from an adjacent pulse by an inter-pulse duration T. In one or more embodiments, the haptic pattern depicted in FIG. 6 may be a default haptic pattern for an electronic device.

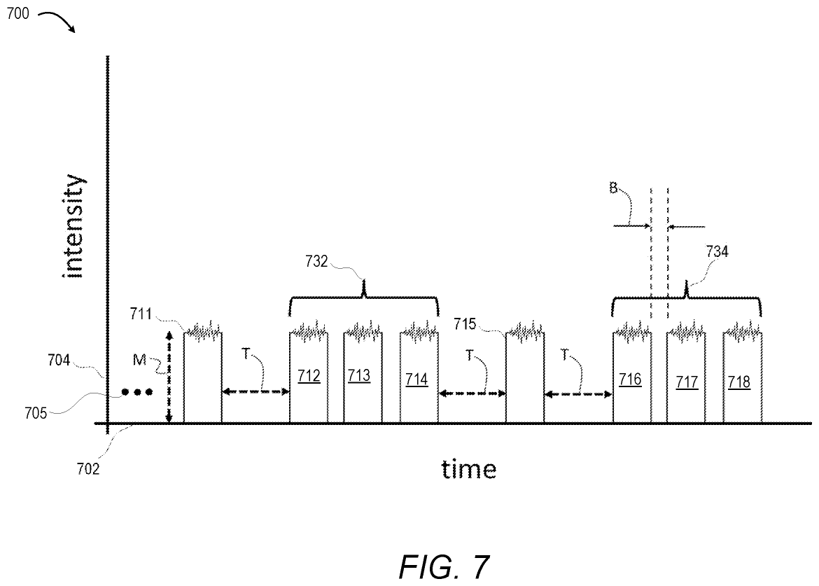

FIG. 7 is a graph 700 of a sixth haptic pattern, according to one or more embodiments. Graph 700 includes a horizontal axis 702 representing time, and a vertical axis 704 representing vibration intensity or amplitude. A sequence of pulses, indicated as 711-718 are shown, each pulse having a similar intensity (amplitude) and duration to the pulses 611-616 shown in FIG. 6. However, instead of being periodic with the inter-pulse duration T between adjacent pulses as shown in graph 600 of FIG. 6, in the graph 700 of FIG. 7, there is a single pulse 711, followed by a burst 732 of multiple pulses 712, 713, and 714. Then the pattern repeats with single pulse 715, followed by a burst 734 of multiple pulses 716, 717, and 718. The inter-pulse duration within a burst is denoted generally by B, where B is less than T. In embodiments, the inter-pulse duration T ranges from 400 milliseconds to 600 milliseconds, and the inter-pulse duration B ranges from 100 milliseconds to 200 milliseconds. The burst patterns shown in graph 700 can serve to make the haptic pattern more noticeable to a user. In one or more embodiments, an electronic device uses the haptic pattern depicted in FIG. 6 as an initial haptic pattern. In response to detecting a drop in efficacy of the initial haptic pattern, disclosed embodiments switch to a new haptic pattern for upcoming alerts, such as depicted in FIG. 7. The burst patterns (732, 734) depicted in FIG. 7 can be noticeable to a user when the user is not used to the pattern. As shown in FIG. 7, one or more embodiments can provide a haptic pattern that alternates between a single pules (711, 715), and bursts of pulses (732, 734). Over time, a user may eventually get used to the pattern depicted in FIG. 7, at which time, disclosed embodiments may switch to a different haptic pattern, including, but not limited to, haptic patterns depicted in FIG. 3-FIG. 5, and/or other different haptic patterns. In one or more embodiments, an initial haptic pattern, which may be similar to the pattern shown in FIG. 6, may be output for a first period of time, to give a user an opportunity to acknowledge an alert. In one or more embodiments, the first period of time ranges from four seconds to seven seconds. The pattern shown in FIG. 7 may occur after the first period. The three dots, shown at 705, indicate that a first period of time precedes pulse 711. In one or more embodiments, the first haptic output has a first pattern of vibration, and changing the haptic setting comprises providing a second pattern of vibration, where the second pattern of vibration is different from the first pattern of vibration.

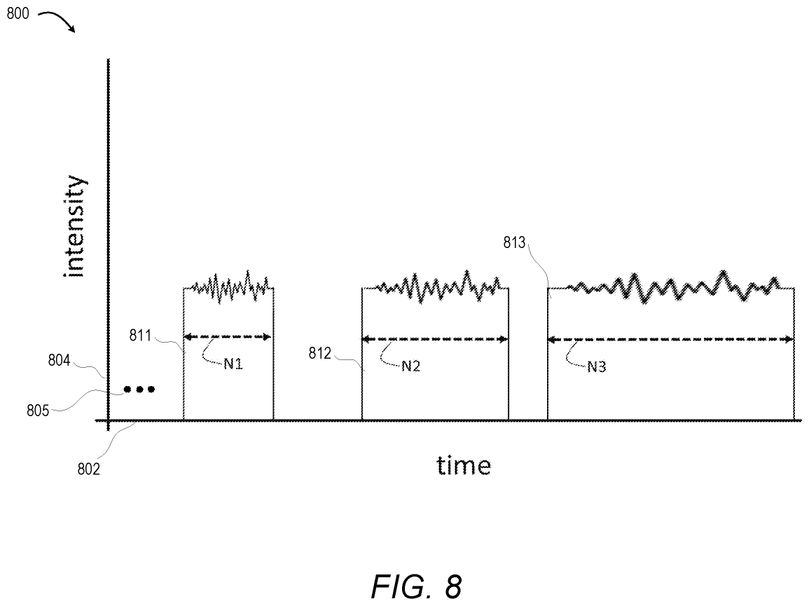

FIG. 8 is a graph 800 of a seventh haptic pattern, according to one or more embodiments. Graph 800 includes a horizontal axis 802 representing time and a vertical axis 804 representing vibration intensity or amplitude. Three pulses, indicated as 811, 812, and 813 are shown, with each pulse having a different duration. Pulse 811 has duration N1, pulse 812 has duration N2, and pulse 813 has duration N3. In one or more embodiments, N1 is less than N2, and N2 is less than N3. In one or more embodiments, N1 ranges from 100 milliseconds to 200 milliseconds, N2 ranges from 400 milliseconds to 600 milliseconds, and N3 ranges from 800 milliseconds to 1 second. Other values are possible in disclosed embodiments. The increasing pulse durations can serve to make the haptic pattern more noticeable to a user. In one or more embodiments, the first haptic output has a first duration of vibration, and changing the haptic setting comprises providing a second duration of vibration, where the second duration of vibration is different from the first duration of vibration. In one or more embodiments, an initial haptic pattern, which may be similar to the pattern shown in FIG. 2, may be output for a first period of time, to give a user an opportunity to acknowledge an alert. In one or more embodiments, the first period of time ranges from four seconds to seven seconds. The pattern shown in FIG. 8 may occur after the first period. The three dots, shown at 805, indicate that a first period of time precedes pulse 811.

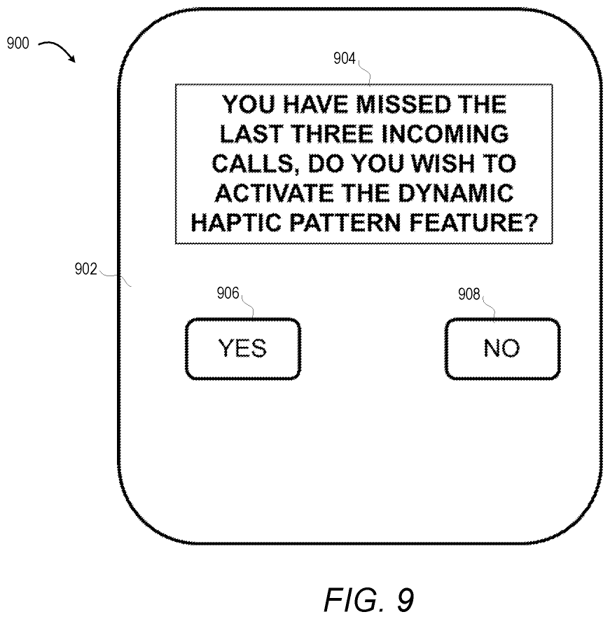

FIG. 9 is an example user interface for providing an option for activation of a dynamic haptic pattern feature, according to one or more embodiments. User interface may be rendered on a display 902 of an electronic device 900 in accordance with disclosed embodiments. Device 900 may be similar to electronic device 100 previously described and shown in FIG. 1. The user interface includes a message field 904. The message field can display a message alerting a user that he/she has missed previous voice calls, and prompting the user to activate a dynamic haptic pattern feature in accordance with disclosed embodiments. A ‘Yes’ button 906 and a ‘No’ button 908 are also rendered. In response to invoking the ‘No’ button 908, the user interface may be closed with no further action taken. In response to invoking the ‘Yes’ button 906, the electronic device 900 activates the dynamic haptic pattern feature. When the dynamic haptic pattern feature is activated, a processor within electronic device 900 causes the electronic device 900 to monitor for response time to events such as incoming voice calls, text alerts, in-app messages, and so on. If the processor detects that the response time is increasing and/or that some events are not being acknowledged at all, disclosed embodiments prompt the user to turn on the dynamic haptic pattern feature, if the feature is not already activated. If the dynamic haptic pattern feature is activated already, then the processor of the electronic device changes the haptic pattern when reduced efficacy of the currently set haptic pattern is detected. In one or more embodiments, the processor of the electronic device changes the haptic pattern periodically, such that when new events occur, a new haptic pattern is used, which may be more noticeable to the user, reducing the likelihood of missing events such as incoming voice calls and messages. In one or more embodiments, the user interface may further enable a user to only consider missed and/or delayed acknowledgement of events when the device is in an ‘on-body’ state. Accordingly, in these embodiments, the dynamic haptic pattern feature does not get activated or prompted for activation due to missed events when the device is not in an ‘on-body’ state. As an example, if the electronic device is left unattended on a table, incoming events may go unacknowledged, but those unacknowledged events are not considered when determining when to invoke or prompt for invoking the dynamic haptic pattern feature. In one or more embodiments, the dynamic haptic pattern feature may be invoked automatically following the user missing and/or providing delayed acknowledgement of a predetermined number of haptic notification events, thus bypassing the user interface shown in FIG. 9.

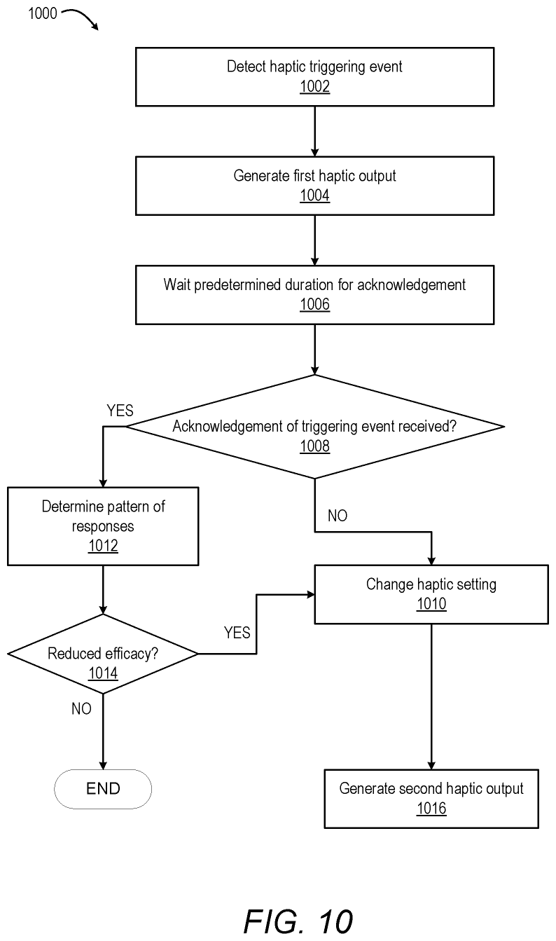

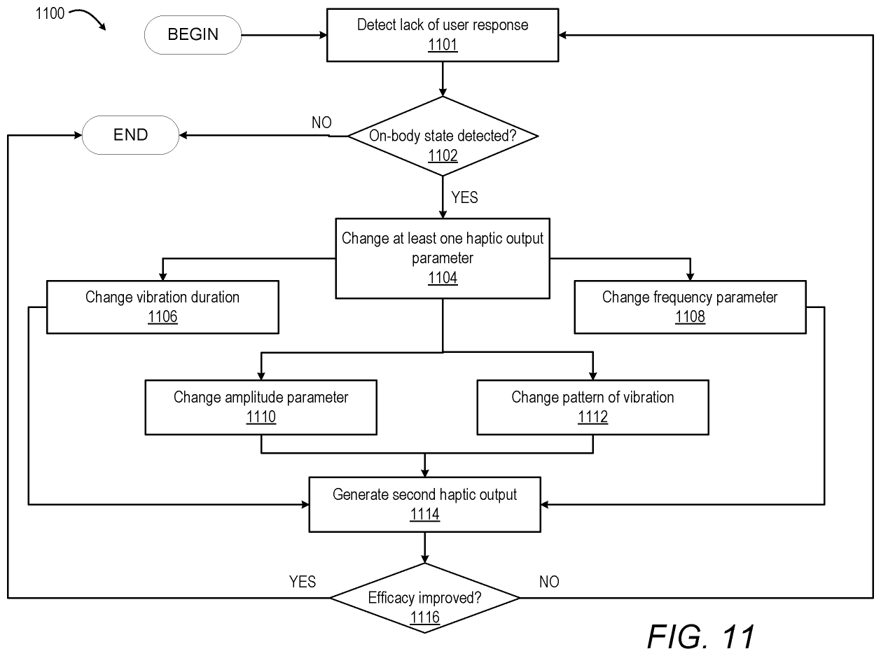

Referring now to the flowcharts presented by FIGS. 10-11, the descriptions of the methods in FIGS. 10-11 are provided with general reference to the specific components and features illustrated within the preceding FIGS. 1-9. Specific components referenced in the methods of FIGS. 10-11 may be identical or similar to components of the same name used in describing preceding FIGS. 1-9. In one or more embodiments, processor 102 (FIG. 1) configures electronic device 100 (FIG. 1) to provide the described functionality of the methods of FIGS. 10-11 by executing program code for one or more modules or applications provided within system memory 120 of electronic device 100.

FIG. 10 depicts a flowchart of a method 1000 for changing a haptic setting of an electronic device to generate a second haptic output that differs from the first haptic output, according to one or more embodiments. The method 1000 starts at block 1002, where a haptic triggering event is detected. The haptic triggering event can include, but is not limited to, an incoming voice call, an incoming text message, an incoming instant message, an incoming application message, and so on. The method 1000 continues with block 1004, where a first haptic output is generated. In embodiments, the first haptic pattern can include a default haptic pattern. In one or more embodiments, the default haptic pattern can include a pattern such as depicted in FIG. 2 or FIG. 6. The method 1000 continues to block 1006, where the method 1000 includes waiting a predetermined duration for an acknowledgement. In one or more embodiments, in the case of an incoming voice call, the acknowledgement can include the user answering or declining the incoming voice call. In one or more embodiments, in the case of an incoming text-based alert or message, the acknowledgement can include the user opening and/or clearing the acknowledgement. If, at block 1008, the acknowledgement of the triggering event is not received, then the method 1000 continues with changing the haptic setting at 1010. The method 1000 then continues with generating a second haptic output at block 1016. If, at block 1008, the acknowledgement of the triggering event is received, then the method 1000 continues to block 1012, where a pattern of responses is determined. The pattern can include a running average of the time for acknowledging incoming voice calls, incoming messages, and the like. Thus, embodiments can include determining a pattern of responses to multiple occurrences of the first haptic output over a period of time. If the average acknowledgement time is increasing over time, the increasing average acknowledgement time can be indicative of reduced efficacy. In one or more embodiments, a baseline is established when the dynamic haptic pattern feature of the disclosed embodiments is activated for the first time. The processor of the electronic device may record the average time required for acknowledgement. If the average time required for acknowledgement increases by a predetermined percentage over a baseline value (e.g., greater than 25 percent), then the acknowledgement time can be indicative of reduced efficacy of haptic alerts. At block 1014, a check is made to determine if efficacy of the haptic alerts is reduced. If it is determined at block 1014 that the efficacy is not reduced, then the method 1000 ends. If, at block 1014, it is determined that the efficacy is reduced, then the method 1000 continues to block 1010 where the haptic setting is changed, followed by generating a second haptic output at block 1016.

FIG. 11 depicts a flowchart of a method 1100 for changing parameters of a haptic setting, according to one or more embodiments. At block 1101, the processor detects a lack of user response. The lack of user response can include a delay in responding to a haptic alert, and/or not acknowledging a haptic alert at all. At block 1102 a check is made to determine if the electronic device is in an on-body state. An on-body state can include a state where an electronic device is held in a hand, placed in a pocket of a garment currently being worn by a user, and so on. In one or more embodiments, the determination of an on-body state can be performed using input from one or more sensors. These sensors, which can include the body proximity sensor 113 of FIG. 1, can further include, but are not limited to, infrared proximity sensors, ambient light sensors, accelerometers, gyroscopes, and/or pressure sensors. In some embodiments, the determination of an on-body state can include analysis of radio signals from WiFi and/or Bluetooth, which may exhibit changes when an electronic device is in an on-body state. If, at block 1102, it is determined that the electronic device is currently not in an on-body state, then the method 1100 ends. If, at block 1102, it is determined that the electronic device is currently in an on-body state, then the method continues to block 1104 where at least one haptic parameter is changed. In one or more embodiments, the changing of at least one haptic parameter can include changing one or more of vibration duration, frequency, amplitude, and/or rhythmic pattern. Thus, from block 1104, the method 1100 can proceed to change vibration duration at block 1106, change frequency parameter at block 1108, change amplitude parameter at block 1110, and/or change a pattern of vibration at block 1112. From each of block 1106, block 1108, block 1110, and/or block 1112, the method continues to block 1114 where a second haptic output is generated using the changed parameter. The method 1100 then continues to block 1116 for an evaluation of improved haptic output efficacy. In one or more embodiments, the evaluation of improved haptic output efficacy can include monitoring response times for a user to acknowledge events such as incoming voice calls, text messages, and/or other messages and alerts. If the response times are shortened with the new haptic output, then efficacy is deemed to be improved. If at block 1116, haptic output efficacy is deemed to be improved, then the method 1100 ends. If, at block 1116, haptic output efficacy is deemed to not have improved, then the method returns to block 1101. In one or more embodiments, a new haptic output pattern may be generated, and the method 1100 can periodically repeat as needed to maintain an effective haptic output of the electronic device. In one or more embodiments, parameters may be randomly selected by the processor for adjustment, in order to create new haptic output patterns for maintaining haptic output efficacy.

As can now be appreciated, the disclosed embodiments provide improvements in electronic devices that include haptic outputs. Often, it can be observed that an electronic device (e.g., smartphone) is in a pocket of a user, and an important message or call is received and missed because the haptics are not felt. It is human nature to become acclimated to feeling certain patterns of haptic feedback, and over time, the efficacy to sensing the haptic feedback goes down. One or more embodiments can determine that a device has a set of preconfigured or a user defined haptic feedback settings for various events. While the device is set in a vibrate mode, (vibrate-only, with no ringtone generated during an incoming call/message), the haptic response time of the user is monitored and recorded in response to various events over a period of time while the device is stowed as on-body (using various device sensors for on-body detection). Disclosed embodiments determine that the time taken to respond to an event while an electronic device is ‘on-body’ as one of increasing, decreasing or constant over a period of time. In response to determining that the time taken to respond (acknowledgement time) is increasing, or that events are going unacknowledged, disclosed embodiments determine a state of reduced efficacy for the haptic output. In response to determining a decrease in efficacy of the haptics, the haptic output pattern is modified or changed in terms of haptic parameters including, but not limited to, haptics intensity (amplitude), length, and rhythm, thereby enabling the user to recognize and respond to events such as calls, text messages, and notifications when the device is in his/her pocket. In one or more embodiments generative AI (e.g., from artificial intelligence (AI) engines 105 of FIG. 1) is used to dynamically create new haptic patterns. Thus, disclosed embodiments improve the technical field of haptic output in electronic devices.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a memory having stored thereon a dynamic haptic alert (DHA) module for managing an intensity of haptic responses by the electronic device;
a haptic output device;
a processor communicatively coupled to the haptic output device and the memory, and which executes program code of the DHA module, which enables the electronic device to:
detect a haptic triggering event;
generate a first haptic output in response to detecting the haptic triggering event;
wait a predetermined duration for an acknowledgement of the first haptic output; and
in response to the first haptic output not being acknowledged after the predetermined duration, change a haptic setting of the electronic device to generate a second haptic output that has at least one parameter that differs from a corresponding parameter of the first haptic output.

2. The electronic device of claim 1, wherein further the processor enables the electronic device to:
determine a pattern of responses to multiple occurrences of the first haptic output over a period of time; and
in response to the pattern of responses indicating a reduced efficacy in the response time to presentation of the first haptic output, trigger the change in the haptic setting to generate the second haptic output.

3. The electronic device of claim 1, wherein to change the haptic setting and generate the second haptic output, the processor increases an amplitude parameter.

4. The electronic device of claim 1, wherein to change the haptic setting and generate the second haptic output, the processor increases a frequency parameter.

5. The electronic device of claim 1, wherein the first haptic output has a first duration of vibration, and wherein to change the haptic setting and generate a second haptic output, the processor provides a second duration of vibration, wherein the second duration of vibration is different from the first duration of vibration.

6. The electronic device of claim 1, wherein the first haptic output has a first pattern of vibration, and wherein to change the haptic setting and generate a second haptic output, the processor generates a second pattern of vibration that is different from the first pattern of vibration.

7. The electronic device of claim 1, further comprising a body proximity sensor coupled to the processor, and wherein the processor generates the second haptic output in response to detecting an on-body state of the electronic device.

8. A method comprising:
detecting, by an electronic device comprising a haptic output device, a haptic triggering event;
generating a first haptic output in response to detecting the haptic triggering event;
waiting a predetermined duration for an acknowledgement of the first haptic output; and
in response to the first haptic output not being acknowledged after the predetermined duration, changing a haptic setting of the electronic device to generate a second haptic output that has at least one parameter that differs from a corresponding parameter of the first haptic output.

9. The method of claim 8, further comprising:
determining a pattern of responses to multiple occurrences of the first haptic output over a period of time; and
in response to the pattern of responses indicating a reduced efficacy in the response time to presentation of the first haptic output, triggering the change in the haptic setting to generate the second haptic output.

10. The method of claim 8, wherein changing the haptic setting comprises increasing an amplitude parameter.

11. The method of claim 8, wherein changing the haptic setting comprises increasing a frequency parameter.

12. The method of claim 8, wherein the first haptic output has a first duration of vibration, and wherein changing the haptic setting comprises providing a second duration of vibration, wherein the second duration of vibration is different from the first duration of vibration.

13. The method of claim 8, wherein the first haptic output has a first pattern of vibration, and wherein changing the haptic setting comprises providing a second pattern of vibration, wherein the second pattern of vibration is different from the first pattern of vibration.

14. The method of claim 8, further comprising generating the second haptic output in response to detecting an on-body state of the electronic device.

15. A computer program product comprising a non-transitory computer readable medium having program instructions that when executed by a processor of an electronic device that comprises a display, the program instructions configure the electronic device to perform functions comprising:
detecting a haptic triggering event;
generating a first haptic output in response to detecting the haptic triggering event;
waiting a predetermined duration for an acknowledgement of the first haptic output; and
in response to the first haptic output not being acknowledged after the predetermined duration, changing a haptic setting of the electronic device to generate a second haptic output that has at least one parameter that differs from a corresponding parameter of the first haptic output.

16. The computer program product of claim 15, wherein the computer program product further comprises program instructions for:
determining a pattern of responses to multiple occurrences of the first haptic output over a period of time; and
in response to the pattern of responses indicating a reduced efficacy in the response time to presentation of the first haptic output, triggering the change in the haptic setting to generate the second haptic output.

17. The computer program product of claim 15, wherein the computer program product further comprises program instructions for changing the haptic setting by increasing an amplitude parameter.

18. The computer program product of claim 15, wherein the computer program product further comprises program instructions for changing the haptic setting by increasing a frequency parameter.

19. The computer program product of claim 15, wherein the first haptic output has a first duration of vibration, and wherein the computer program product further comprises program instructions for providing a second duration of vibration, wherein the second duration of vibration is different from the first duration of vibration.

20. The computer program product of claim 15, wherein the first haptic output has a first pattern of vibration, and wherein the computer program product further comprises program instructions for providing a second pattern of vibration, wherein the second pattern of vibration is different from the first pattern of vibration.
